(19) United States
(12) Patent Application Publication
(10) Pub. No.: US 2025/0333332 A1
(43) Pub. Date: Oct. 30, 2025

(54) BIOCHAR-BASED WATER PURIFICATION SYSTEM

(71) Applicant: HARSHIL AHUJA, san jose, CA (US)

(72) Inventor: HARSHIL AHUJA, san jose, CA (US)

(21) Appl. No.: 18/648,476

(22) Filed: Apr. 29, 2024

(51) Int. Cl. C02F 1/28

(52) U.S. Cl. CPC C02F 1/283; C02F 2307/02

(57) ABSTRACT

In one aspect, a biochar-based water purification system includes a first cover configured to receive a liquid source. A housing element is configured to house a plurality of the interior elements. A plurality of interior elements includes one or more filtration elements that include at least one biochar-based water purification system. A second cover is configured to release a filtered liquid.

### BACKGROUND

There is a need for a water purifier device that is both cost effective and provides safe drinking water. In many areas of the world, families still collect water from unclean and unsafe sources. Current low cost methods such boiling the water in an attempt to clean it may not sufficiently remove other impurities.

### SUMMARY OF THE INVENTION

In one aspect, a biochar-based water purification system includes a first cover configured to receive a liquid source. A housing element is configured to house a plurality of the interior elements. A plurality of interior elements includes one or more filtration elements that include at least one biochar-based water purification system. A second cover is configured to release a filtered liquid.

### BRIEF DESCRIPTION OF THE DRAWINGS

FIG. 1 illustrates an example exploded view water filter, according to some embodiments.

FIG. 2 illustrates an example water filter in an assembled state, according to some embodiments.

FIG. 3 illustrates an example view of a water filter in use with a gravity assisted water input, according to some embodiments.

The Figures described above are a representative set and are not exhaustive with respect to embodying the invention.

### DESCRIPTION OF THE INVENTION

Disclosed are a system, method, and article of manufacture of a biochar-based water purification system. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Activated charcoal can be a form of activated carbon. Activated charcoal can used to filter contaminants from water, air, etc. Activated charcoal can be processed (e.g. activated) to have small, low-volume pores that increase the surface area available for adsorption and/or chemical reactions. Due to its high degree of microporosity, one gram of activated carbon can have a surface area in excess of 3,000 m2 (32,000 sq ft) as determined by gas adsorption.

Biochar can be a lightweight black residue. Biochar can be made of carbon and ashes that remain after the pyrolysis of biomass. Biochar can be a form of charcoal. Biochar can be a solid material obtained from the thermochemical conversion of biomass in an oxygen-limited environment. Biochar is a stable solid that is rich in pyrogenic carbon and can endure in soil for thousands of years.

Water bottle is a container that is used to hold liquids (e.g. water, etc.) for the purpose of transporting a drink while travelling or while otherwise away from a supply of potable water.

### Example Systems and Methods

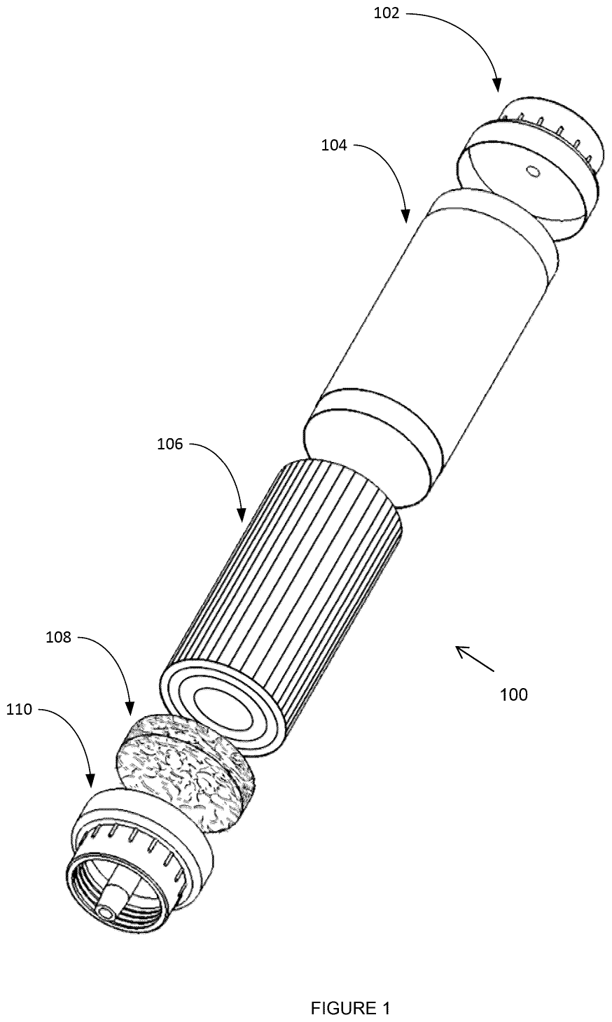

FIG. 1 illustrates an example exploded biochar-based water purification system 100, according to some embodiments. Threaded cover 102 can enable a user to thread a water bottle on biochar-based water purification system 100. A knob and/or other coupling system can be included for inserting and/or attaching a straw and/or straw filtration system as well (e.g. a silicon straw, a straw filer, etc.). Housing element 104 houses the interior elements of biochar-based water purification system 100. Housing element 104 can be made of plastic, metal, etc.

The filtration elements of biochar-based water purification system 100 are now discussed. Non-woven fabric 106 can be a non-woven fabric. Non-woven fabric 106 can filter out particles of a specified size (e.g. up to around 0.3-micron sized particles, etc.). in some examples, non-woven fabric 106 can filter 99.97% of the particulates in the liquid input into biochar-based water purification system 100.

Activated charcoal and biochar layer 108 is placed after non-woven fabric 106. The activated charcoal can capture various impurities (e.g. pesticides, etc.). The biochar can be mixed with the activated charcoal to increase the absorption of chemical compounds. The mixture can be a one-to-one ratio of biochar to activated charcoal. In one example, there can be six grams of activated charcoal and six grams of biochar in the activated charcoal and biochar layer 108.

In some embodiments, the activated charcoal and biochar layer 108 can be wrapped in a non-woven fabric. In some example, another non-woven fabric can keep the activated charcoal and biochar layer 108 from entering the microfibers of other portions of biochar-based water purification system 100.

Threaded cover 110 can be similar to threaded cover 102. Threaded cover 110 can be a cap that is welded onto biochar-based water purification system 100.

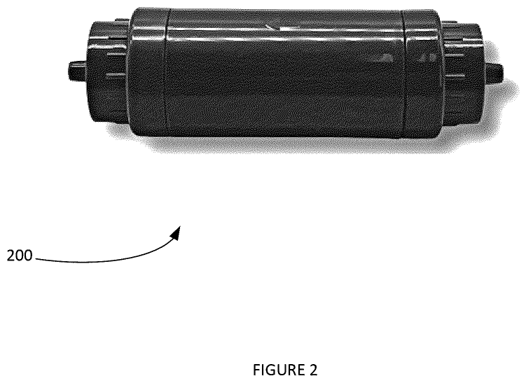

FIG. 2 illustrates an example biochar-based water purification system 200 in an assembled state, according to some embodiments.

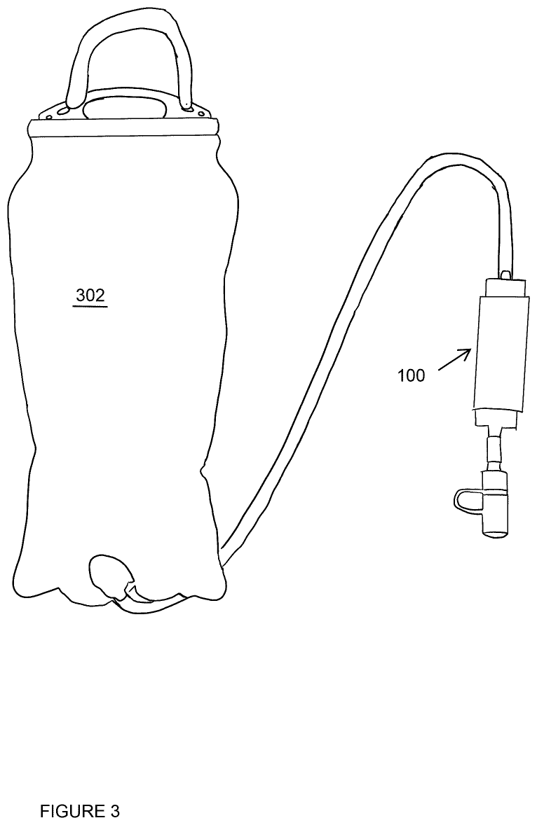

FIG. 3 illustrates an example view of a water filter in use with a gravity assisted water input, according to some embodiments. A gravity assisted water input can obtain water from a water container 302 placed above biochar-based water purification system 100. A tube can connect water container 302 to biochar-based water purification system 100 such that water flows into biochar-based water purification system 100.

### CONCLUSION

Although the present embodiments have been described with reference to specific example embodiments, various modifications and changes can be made to these embodiments without departing from the broader spirit and scope of the various embodiments. Accordingly, the specification and drawings are to be regarded in an illustrative rather than a restrictive sense.

What is claimed by this United States patent:

1. A biochar-based water purification system, comprising:
a first cover configured to receive a liquid source;
a housing element configured to house a plurality of the interior elements;
a plurality of interior elements comprising:
one or more filtration elements comprising at least one biochar-based water purification system; and
a second cover configured to release a filtered liquid.

2. The biochar-based water purification system of claim 1, wherein the plurality of interior elements comprises a non-woven fabric.

3. The biochar-based water purification system of claim 2, wherein the non-woven fabric is configured to filter out 0.3-micron sized particles.

4. The biochar-based water purification system of claim 3, wherein the plurality of interior elements comprises a combined activated charcoal and biochar layer.

5. The biochar-based water purification system of claim 4, wherein the combined activated charcoal and biochar layer receives the output liquid of the non-woven fabric.

6. The biochar-based water purification system of claim 5, wherein the combined activated charcoal and biochar layer comprises a mix of activated charcoal and biochar.

7. The biochar-based water purification system of claim 5, wherein the combined activated charcoal and biochar layer comprises a mixture with a one-to-one ratio of biochar to activated charcoal.

8. The biochar-based water purification system of claim 5, wherein the combined activated charcoal and biochar layer comprises six grams of activated charcoal and six grams of biochar.

9. The biochar-based water purification system of claim 5, wherein the combined activated charcoal and biochar layer is wrapped in another non-woven fabric.

10. The biochar-based water purification system of claim 9, wherein the combined activated charcoal and biochar layer is n-centimeters in width.

11. The biochar-based water purification system of claim 1,
wherein the first cover is configured to receive a water bottle mouth, and
wherein the first cover is configured as a threaded interior to receive a threaded exterior of a water bottle.

12. The biochar-based water purification system of claim 1, wherein the first cover is configured as a knob coupling system inserting and attaching a straw filtration system.

13. The biochar-based water purification system of claim 1, wherein the housing element is composed of a hard plastic.

14. The biochar-based water purification system of claim 13, wherein the housing element comprises a hollow cylinder.

15. The biochar-based water purification system of claim 13, wherein the housing element comprises a hollow cylinder.
